(19) United States
(12) Patent Application Publication
(10) Pub. No.: US 2007/0012010 A1
(43) Pub. Date: Jan. 18, 2007

(54) Method and apparatus for controlling a windrower header flotation system during removal of the header

(76) Inventors: Douglas R. Otto, Ephrata, PA (US); Robert L. Fackler, Ephrata, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 11/487,006

(22) Filed: Jul. 14, 2006

Related U.S. Application Data
(60) Provisional application No. 60/699,271, filed on Jul. 14, 2005.
(60) Provisional application No. 60/699,550, filed on Jul. 15, 2005.

(51) Int. Cl. A01D 41/14

(52) U.S. Cl. 56/10.2 R

(57) ABSTRACT

A method and apparatus for controlling the flotation system of an agricultural harvesting machine such as a windrower, wherein the system is programmed to be automatically operable for entering a header remove mode when operating conditions indicate an intent to remove the header, which conditions can be, for instance, the setting or a flotation force value for the system to zero or near zero, and which will automatically exit the header remove mode when conditions indicate an intent to return to normal operation, for instance, when a flotation force is increased to at least a predetermined value.

This application claims the benefit of U.S. Provisional Application Nos. 60/699,271, filed Jul. 14, 2005, and 60/699,550, filed Jul. 15, 2005.

### TECHNICAL FIELD

The present invention relates to agricultural windrowers and, more particularly, to a method embodied in a software program and apparatus for controlling the hydraulics during the removal of a windrower header.

### BACKGROUND OF THE INVENTION

U.S. Pat. No. 6,901,729, is incorporated herein by reference in its entirety. This patent describes a header flotation system that is referred to as “non-independent”. U.S. Provisional Application Nos. 60/699,271, filed Jul. 14, 2005, and 60/699,550, filed Jul. 15, 2005, are also incorporated herein by reference in their entirety.

It is the non-independent embodiment that provides the best example of the type of system with which the program of the instant invention can/should be used.

The present invention relates generally to harvesting machines of the type that require flotation systems for permitting their headers to ride lightly up and over rises in the terrain during field operation, and particularly to a hydraulic header lift and flotation system for such a machine that will provide the dual functions of header lift and flotation.

Header flotation systems typically use extension springs, either hydraulically or manually adjusted, bell cranks and other linkages to provide the desired function. The structure generally requires numerous components and large extension springs, and it is quite difficult to develop the mechanical components required to float the broad range of header sizes available even requiring different tractors or frames having their own flotation systems designed to meet their own particular header weight requirements.

Some manufacturers are using an accumulator and hydraulic cylinders to perform the flotation function. These machines typically use separate hydraulic cylinders for the lift and flotation functions, and they lack the capability of independently adjusting the flotation force for each side of the header. Additionally, some headers are not inherently balanced side to side. Special considerations must be made to float and lift these headers evenly by adding ballast, which can become unreasonably heavy or awkward, or modifying the lift geometry of one side.

It would be quite beneficial to have a header lift and flotation system that employs a single hydraulic cylinder for each side of the header, simplifying the controls and mechanical components necessary to perform these functions.

It would also be beneficial to have a header lift and flotation system automatically operable for entering a header remove mode when operating conditions indicate an intent to remove the header, and automatically exiting the header remove mode when conditions indicate an intent to return to normal operation.

### SUMMARY OF THE DISCLOSURE

Accordingly, it is an object of the present invention is to provide a hydraulic lift and flotation system for the header of a crop harvesting machine that employs a single hydraulic cylinder for each side of the header.

Another object of the present invention is to provide a hydraulic lift and flotation system to be used with both heavy and light headers/conditioners, i.e., a broad range of header sizes and weights.

It is another object of the instant invention to provide a more simplified structure that presents greater flexibility in locating the accumulator as opposed to extension springs and necessary linkages, with fewer pivot points to wear and fewer parts to manufacture and assemble.

It is still another object of the instant invention to provide a flotation and lift system that requires no dealer or customer assembly.

It is an even still further object of the instant invention to provide a hydraulic header flotation and lift system that reduces hydraulic and mechanical shock loading when raising the header in a less than fully raised position, improving the ride comfort for the operator and improving hydraulic and structural durability of the harvester.

It is yet another object of this invention to provide an improved hydraulic header lift and flotation system that is durable in construction, inexpensive of manufacture, carefree of maintenance, facile in assemblage, and simple and effective in use.

It is still another object of the invention to provide a header lift and flotation system automatically operable for entering a header remove mode when operating conditions indicate an intent to remove the header, and automatically exiting the header remove mode when conditions indicate an intent to return to normal operation.

These and other objects are attained by providing a hydraulic lift/flotation system for the header of a crop harvesting machine. Each side of the header is supported by a single cylinder that performs both the flotation and lift functions. To accommodate unbalanced headers (center of gravity not centered between the lift arms), hydraulic oil is sent to the return side of the lift cylinder on the lighter side of the header, thus resulting in even raising, lowering and float. Additionally, the system is programmed to be automatically operable for entering a header remove mode when operating conditions indicate an intent to remove the header, and automatically exiting the header remove mode when conditions indicate an intent to return to normal operation.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a partial side elevational view of a crop harvesting machine of the type with which the invention may be used, also showing a simplified side view of the lift and flotation system of the instant invention; and

FIG. 2 is a hydraulic schematic view of one embodiment of the hydraulic system of the instant invention;

FIG. 3 is a schematic of the hydraulic, mechanical and electrical sub-systems that cooperate to produce the system of FIGS. 1 and 2;

FIG. 4 is a high level flow diagram of steps of a preferred embodiment of a computer program of the invention;

FIG. 4a is a continuation of the diagram of FIG. 4;

FIG. 5 is a written listing of steps of the preferred program of the invention;

FIG. 6 is a written listing of further steps of the preferred program of the invention;

FIG. 7 is a written listing of further steps of the preferred program of the invention;

FIG. 8 is a written listing of still further steps of the preferred program of the invention;

FIG. 9 is a written listing of still further steps of the preferred program of the invention;

FIG. 10 is a written listing of still further steps of the preferred program of the invention;

FIG. 11 is a written listing of still further steps of the preferred program of the invention;

FIG. 12 is a written listing of still further steps of the preferred program of the invention;

FIG. 13 is a written listing of still further steps of the preferred program of the invention;

FIG. 14 is a written listing of still further steps of the preferred program of the invention;

FIG. 15 is a written listing of still further steps of the preferred program of the invention;

FIG. 16 is a written listing of still further steps of the preferred program of the invention;

FIG. 17 is a written listing of still further steps of the preferred program of the invention;

FIG. 18 is a written listing of still further steps of the preferred program of the invention;

FIG. 19 is a written listing of still further steps of the preferred program of the invention;

FIG. 20 is a written listing of still further steps of the preferred program of the invention;

FIG. 21 is a written listing of still further steps of the preferred program of the invention;

FIG. 22 is a written listing of still further steps of the preferred program of the invention;

FIG. 23 is a written listing of still further steps of the preferred program of the invention;

FIG. 24 is a written listing of still further steps of the preferred program of the invention;

FIG. 25 is a written listing of still further steps of the preferred program of the invention;

FIG. 26 is a written listing of still further steps of the preferred program of the invention;

FIG. 27 is a written listing of still further steps of the preferred program of the invention;

FIG. 28 is a written listing of still further steps of the preferred program of the invention;

FIG. 29 is a written listing of still further steps of the preferred program of the invention;

FIG. 30 is a written listing of still further steps of the preferred program of the invention; and

FIG. 31 is a written listing of still further steps of the preferred program of the invention.

### DETAILED DESCRIPTION OF THE PREFERRED EMBODIMENTS

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience, and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail.

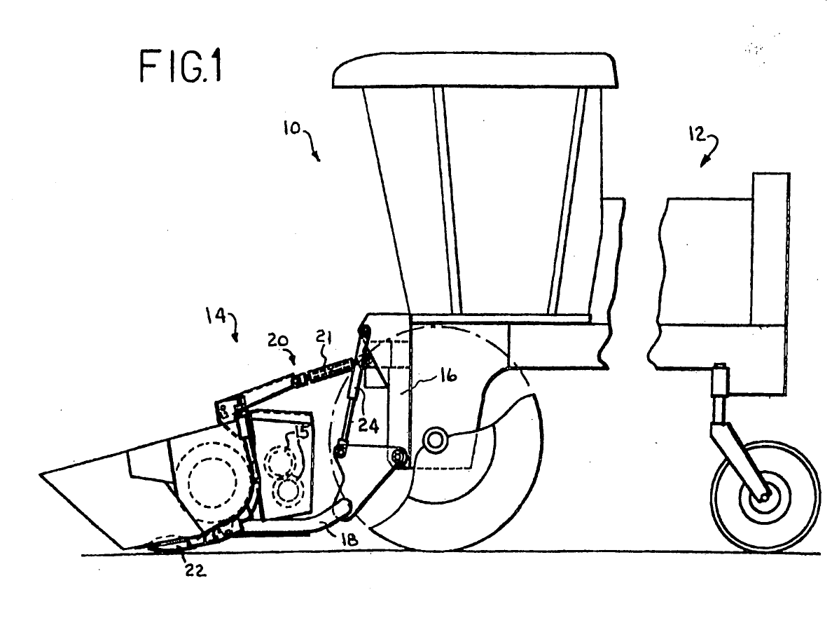

FIG. 1 shows the present invention utilized in connection with a self-propelled windrower 10; however, it will be appreciated that the principles of the present invention are not limited to a self-propelled windrower, or to any specific type of harvesting machine.

In the illustrated embodiment, the self-propelled windrower 10 comprises a tractor 12 and a header 14, the header 14 being attached to the front end of the frame 16 or chassis of the tractor 12. The header may be of generally any suitable construction and design, and may include not only crop-harvesting mechanisms, but also crop conditioners such as elongate rolls 15. Such attachment of the header 14 to the frame 16 is achieved through a pair of lower arms 18 (only the left one being shown, the right being generally the same) pivoted at one end to the frame 16 and at the other end to the header 14, as well as through a central upper link 20. The link 20 may take the form of a single double-acting hydraulic cylinder 21 whose extension and retraction is controlled by the operator to remotely control the angle of sickle bar 22 on the lower front of the header 14.

A single lift/flotation cylinder 24, interconnecting the lower arm 18 and the frame 16 supports each side of the header, i.e., each side of the header is supported by its own lift/flotation cylinder (again, only the left one being shown in this FIG. 1).

More specifically, the control system accomplishes two generally separate control functions, one for the right side lift/flotation cylinder and one for the left.

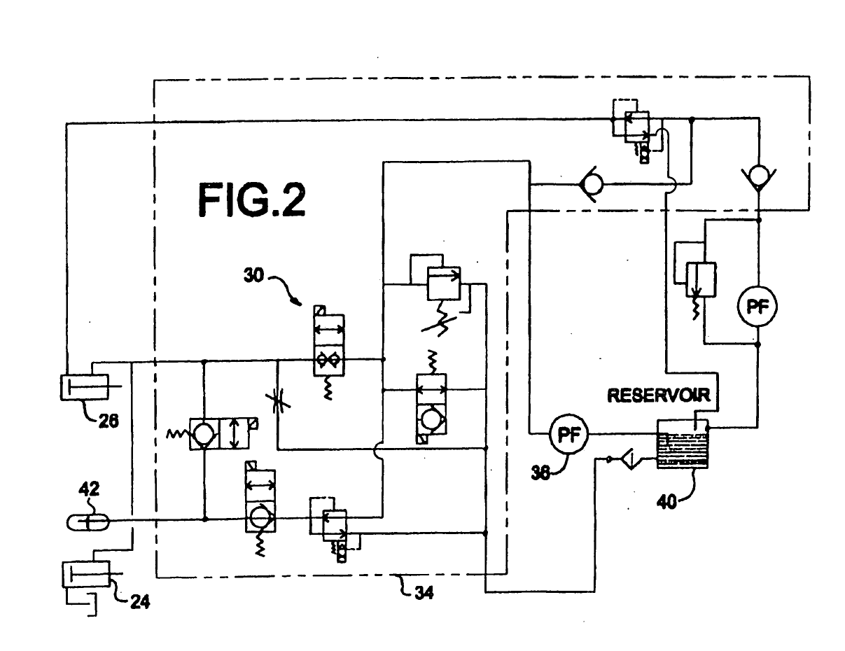

Directing attention now to FIG. 2, the hydraulic control system for left cylinder 24 and a right cylinder 26 can be seen to include an electro-hydraulic subsystem generally depicted as 30. For convenience of assembly and operation, the majority of the components are housed in a single valve body 34 with appropriately located ports and other necessary connection devices and fixtures. A fixed displacement pump 36 moves the hydraulic fluid into subsystem 30 from reservoir 40, through the various circuits as directed by control valves, to a single accumulator 42, to hydraulic cylinders 24, 26 and back to reservoir 40 as appropriate.

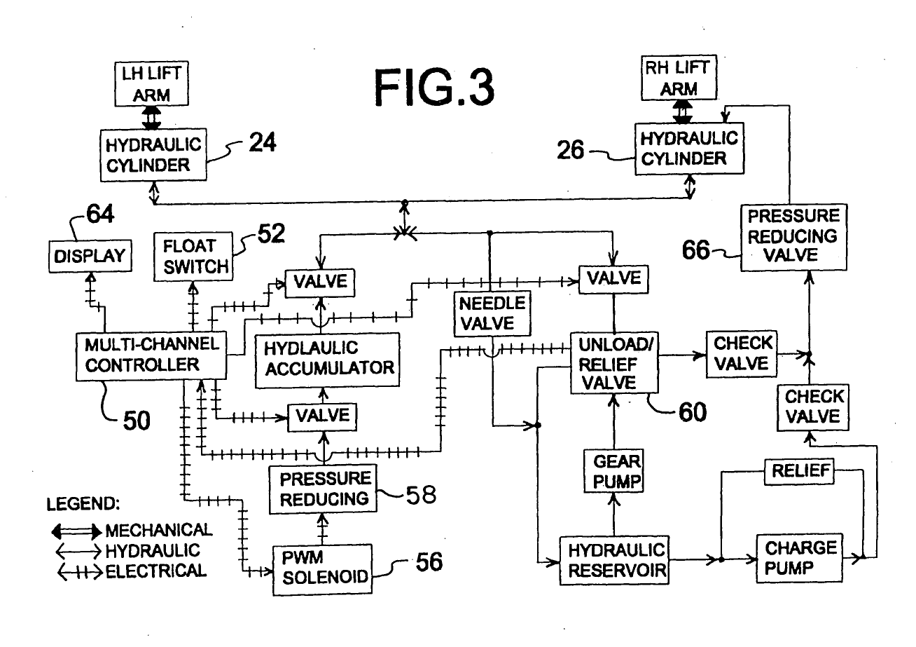

FIG. 3 provides a more detailed depiction of the complete control system and subsystems. The hydraulic system, as shown also in FIG. 2, additionally depicts the electrical control and mechanical subsystems. Importantly, this figure depicts the multi-channel programmable controller 50 which exchanges electrical signals from the float switch 52 (also referred to in the written program code of the invention as trim switch), the PWM (pulse width modulated) solenoid 56 of the proportional pressure reducing valve (PPRV) or (PRV) 58, the unload/relief valve 60, and other valves to manage the lift and flotation functions as established by the operator through the appropriate switch and shown on display 64.

The hydraulic cylinders, attached to respective ends of the header, perform both the lift and flotation functions. The lifting and floating function is achieved by coupling the lifting end of the hydraulic cylinders to each other and then to a hydraulic pump, control manifold, and accumulator. The operator sets the desired flotation force by actuating the float switch 52, located on the operator's console. The set points can range from zero or near zero, to a range of values greater than zero or near zero. One switch position allows hydraulic oil to enter the accumulator (increasing the hydraulic pressure), which reduces the header contact force, or flotation force, with the ground. The other switch position allows oil to exit the accumulator (reducing the hydraulic pressure), which increases the header contact force with the ground. Once the flotation force is set, the controller 50 will normally cause the control valves to return to this preset flotation condition whenever the float mode is selected, irrespective of subsequent header lift and lower movements. To accommodate unbalanced headers (the header center of gravity is not centered between the lift arms), hydraulic oil is applied to the return side of the lift cylinder on the lighter side of the header. The addition of a defined hydraulic pressure on the back side of the cylinder results in the same lifting pressure to be required for each side. The header will then raise, lower, and float evenly. The result is the same as changing the lift geometry or adding ballast to the header. This function is referred to as the “hydraulic counterweight”.

The hydraulic oil is supplied from the hydraulic ground drive charge pump, which provides constant pressure any time the engine is running. To prevent cavitation of the charge pump during rapid changes in system volume, such as during the header lower cycle, makeup oil is supplied from the header lift pump. The operator sets the hydraulic counterweight by turning a manual control valve 66 to apply more weight (hydraulic pressure) to the light side of the header until the header raises and lowers to a level condition. If too much weight is applied, the operator simply turns the valve in the opposite direction. Once the correct setting is established, the hydraulic counterweight will not need to be readjusted during machine operation. Re-adjustment will only become necessary if the header builds up with debris or upon exchange with another header.

For headers that experience severe changes in balance during normal operation, i.e., draper headers with deck-shift, an electro-hydraulic valve can be installed in place of the manual control valve. This electro-hydraulic valve is adjusted from a rocker switch on the operator's console. The operator then sets the hydraulic counterweight for each deck position. Once these values are established, the control valve will adjust automatically as the deck positions are selected.

In the present example of the windrower 10 and system 30, they are configured such that the lighter side of header 14 is supported by cylinder 26, and a hydraulic counterweight can be is applied to cylinder 26 using pressure reducing valve 66 (FIGS. 2 and 3) or an optional electro-hydraulic valve, as just mentioned. During normal operation, either of these arrangements can be used to maintain header 14 level.

From time to time, it will be desirable to remove header 14 from windrower 10. This typically entails raising the header using cylinders 24 and 26. Jack stands, either included on and pivotable downward from header 14, or separate therefrom, or other support structure for supporting header 14 independently of lower arms 18, are then deployed. Pins connecting header 14 with lower arms 18 are then removed. Lower arms 18 can now be lowered and separated from header 14, and upper link 20 disconnected, to enable driving windrower 10 separately of and away from header 14. Since any flotation force would be outwardly acting on cylinders 24 and 26, the presence of such flotation force is typically viewed as a detriment when it is desired to disconnect lower arms 18 from header 14. Lower arms 18 are typically cooperatively received in cups on header 14 and often require some exertion of downward force to release from the cups. Sometimes, the operator will exit the operator cab of windrower 10 and apply his or her weight to lower arms 18 to release them from header 14. Any upward force, such as a flotation force, would counter this, and thus be undesirable. As result, the operator typically will adjust or set the flotation force using float switch 52 down to zero or near zero. Then, when arms 18 are lowered using a header lower command to operate cylinders 24 and 26, because there is no upwardly directed flotation force, arms 18 will typically drop or fall from header 14. With header 14 removed, it may be desirable to raise arms 18, which can be accomplished by a header raise command to operate cylinders 24 and 26. However, from a raised position, it will typically be undesirable to execute a header lower command to lower arms 18 without some flotation force present, as arms 18 will essentially just drop. Therefore, it is desirable to have an automatic routine for operation of controller 50 which accommodates operation of system 30 in a header remove mode.

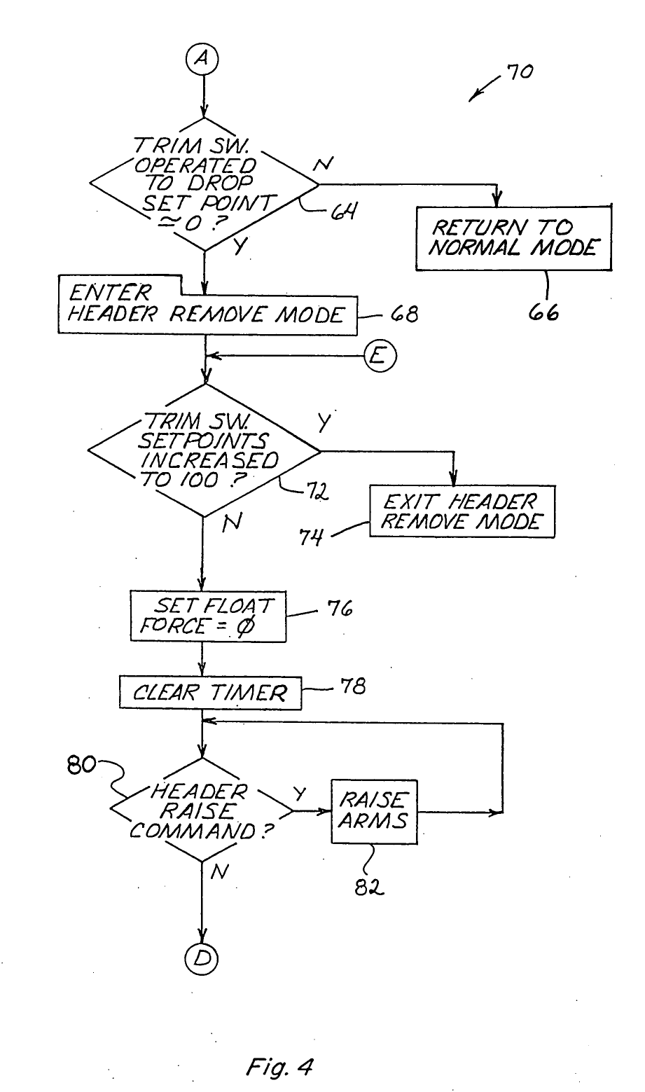

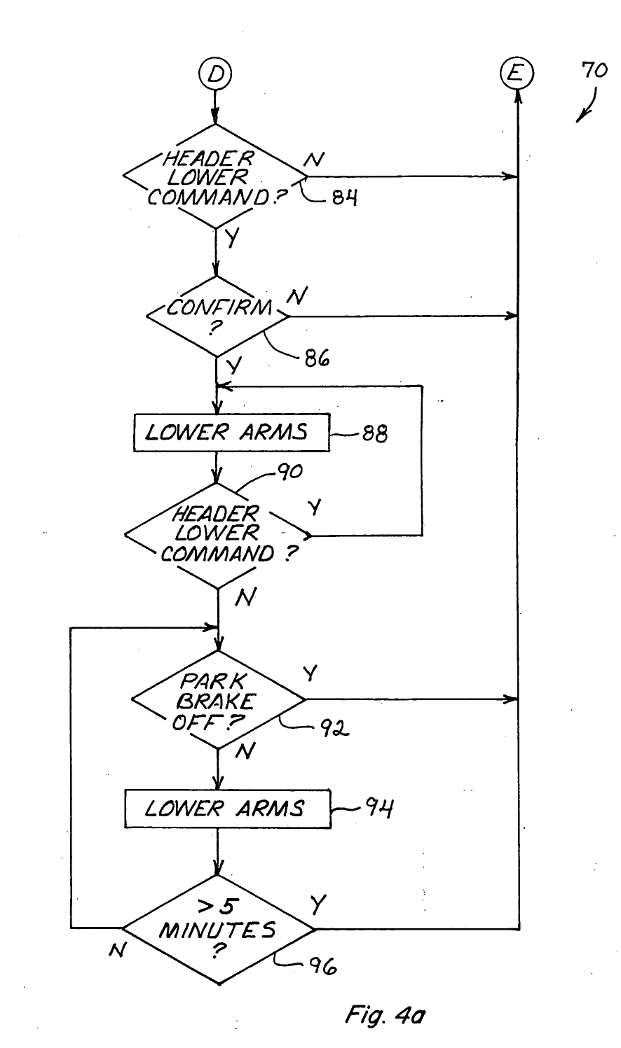

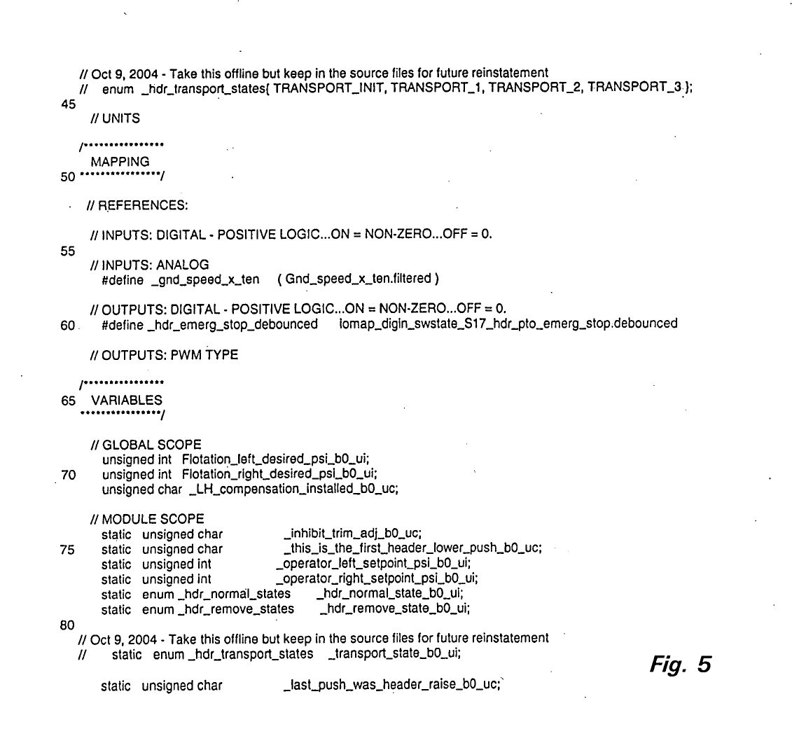

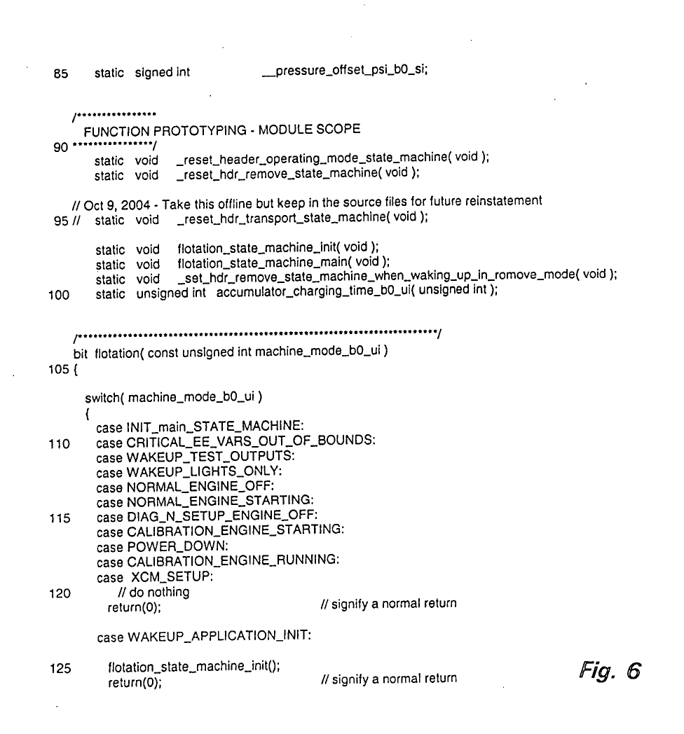

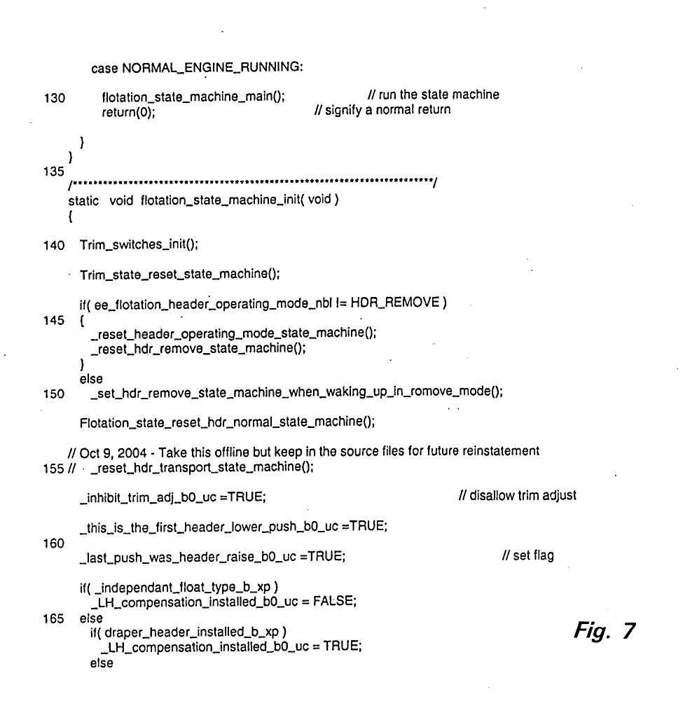

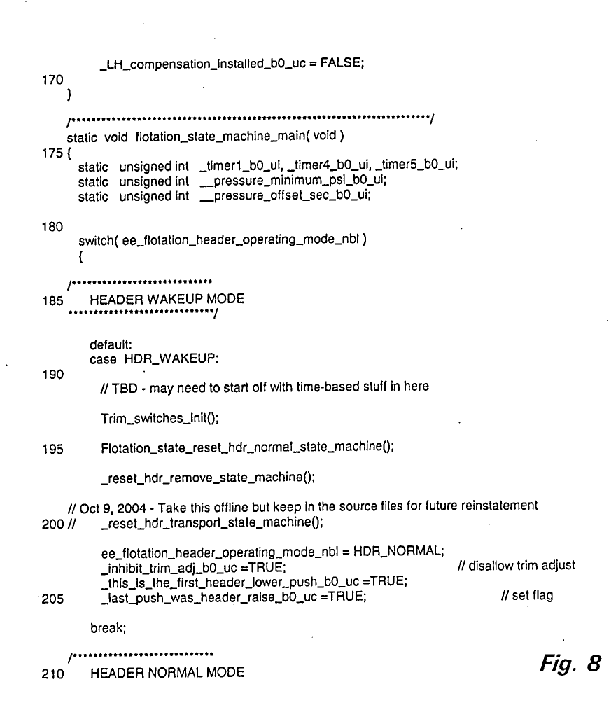

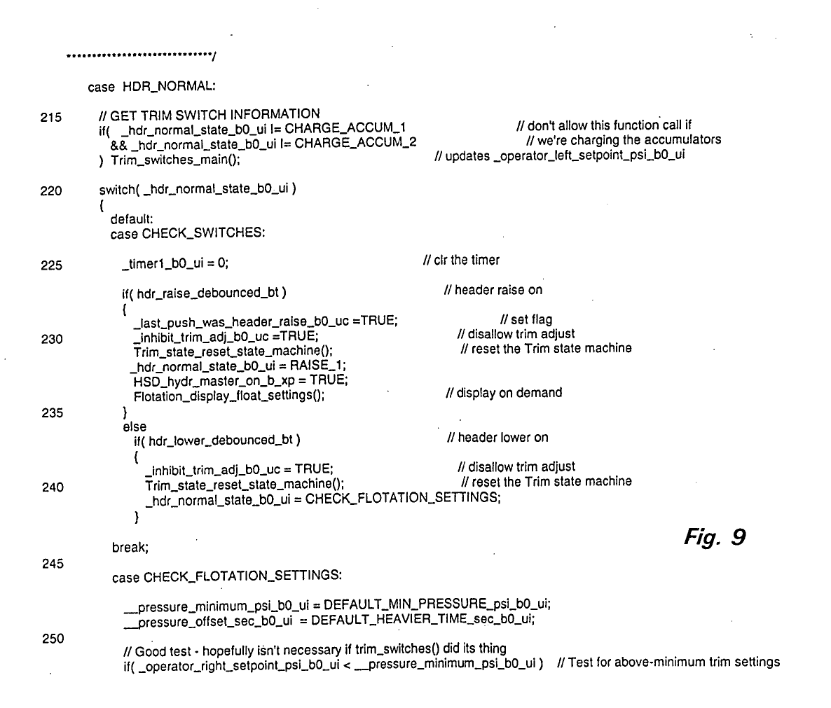

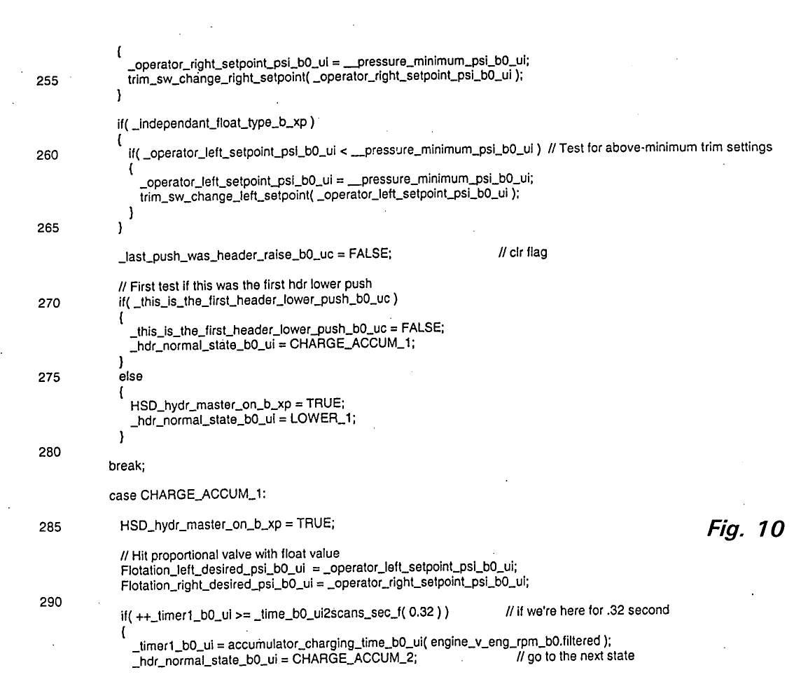

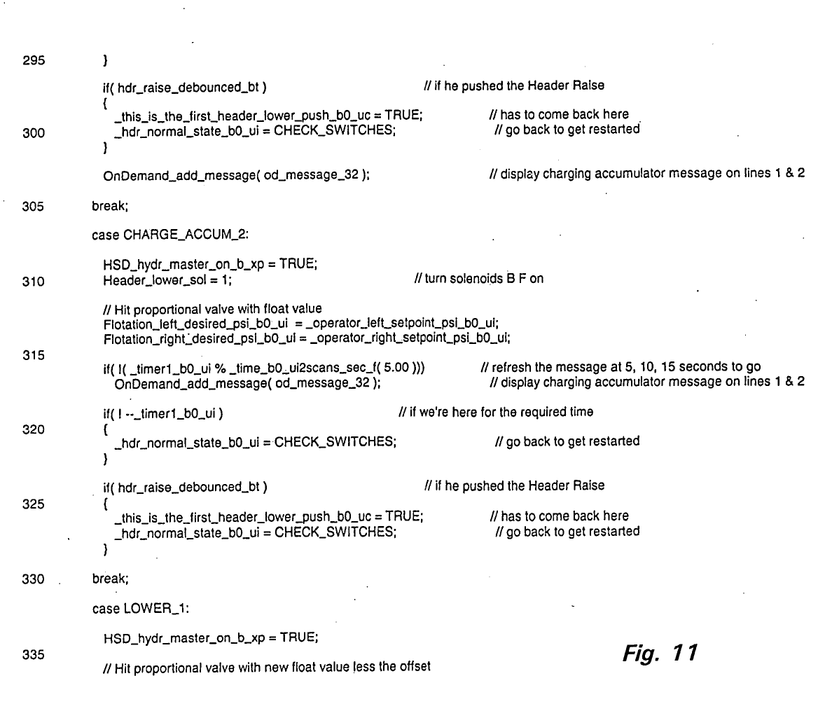

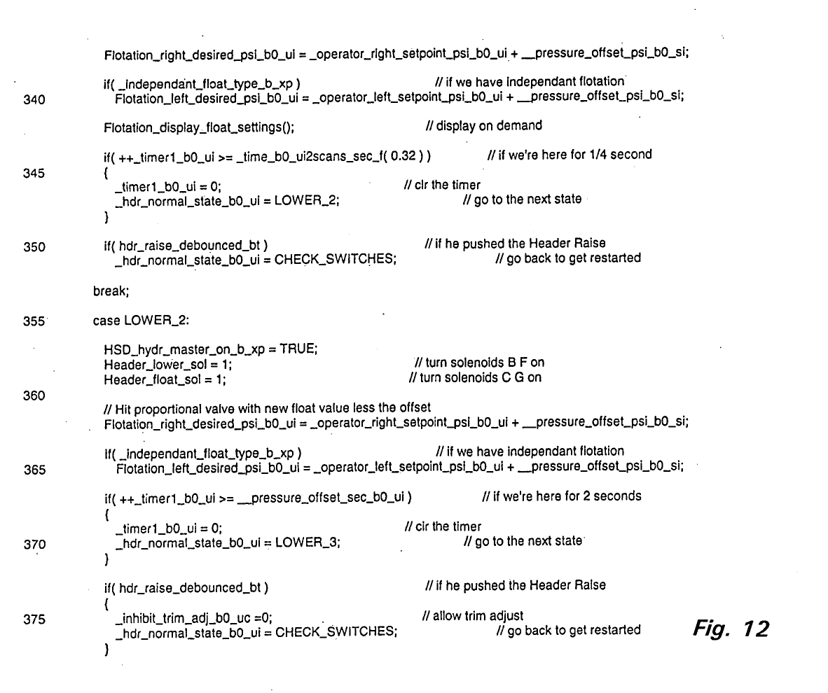

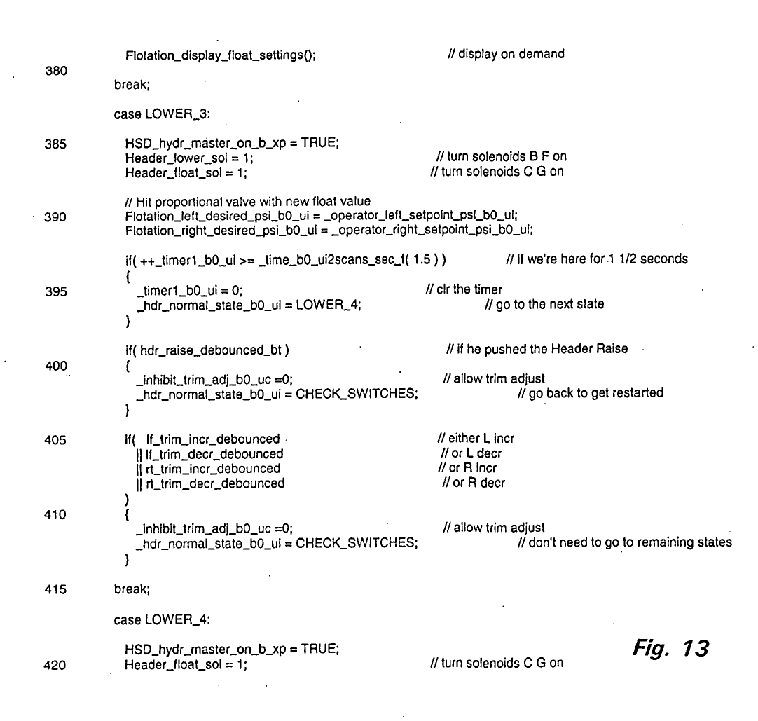

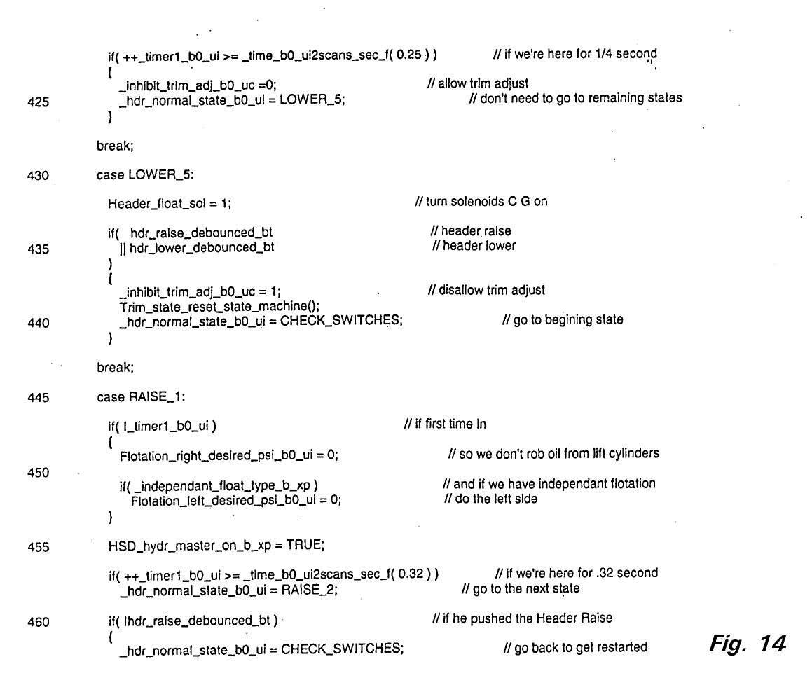

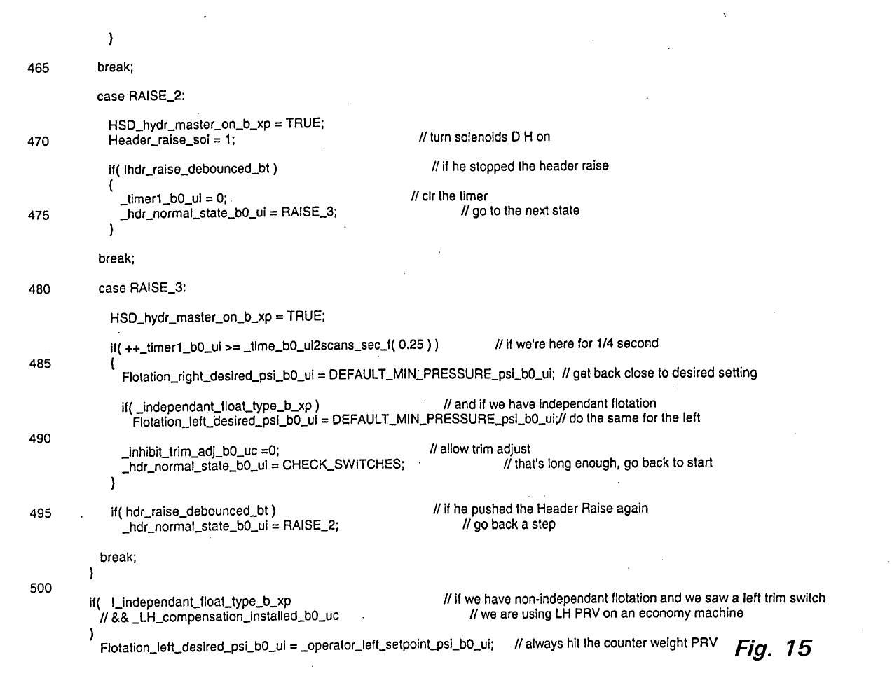

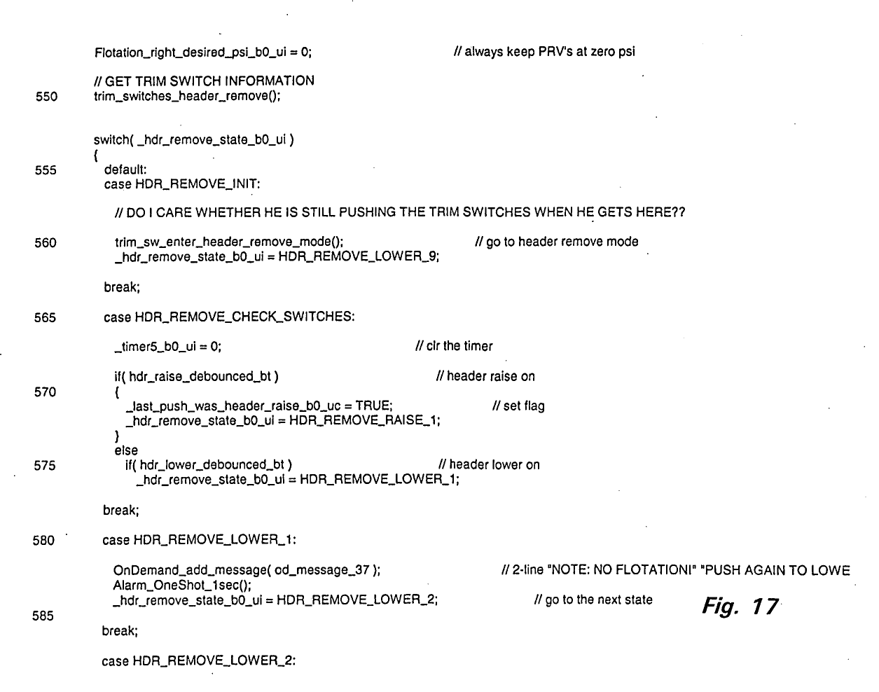

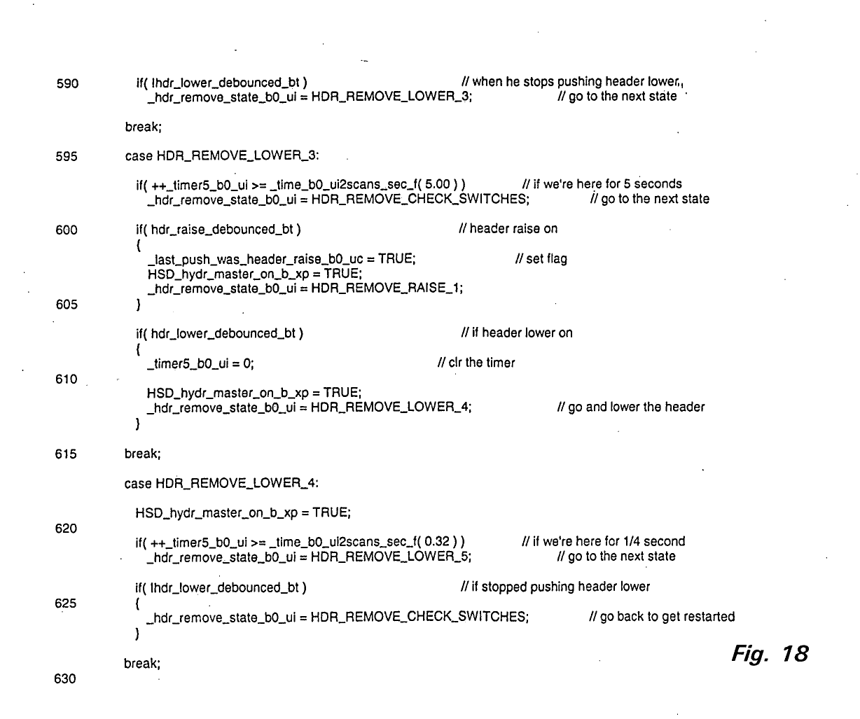

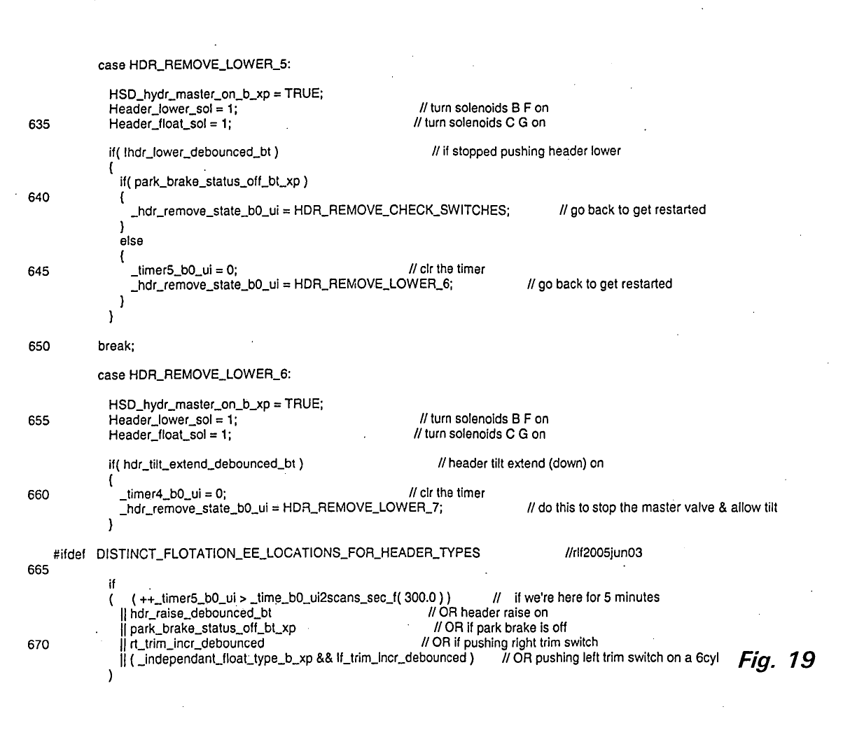

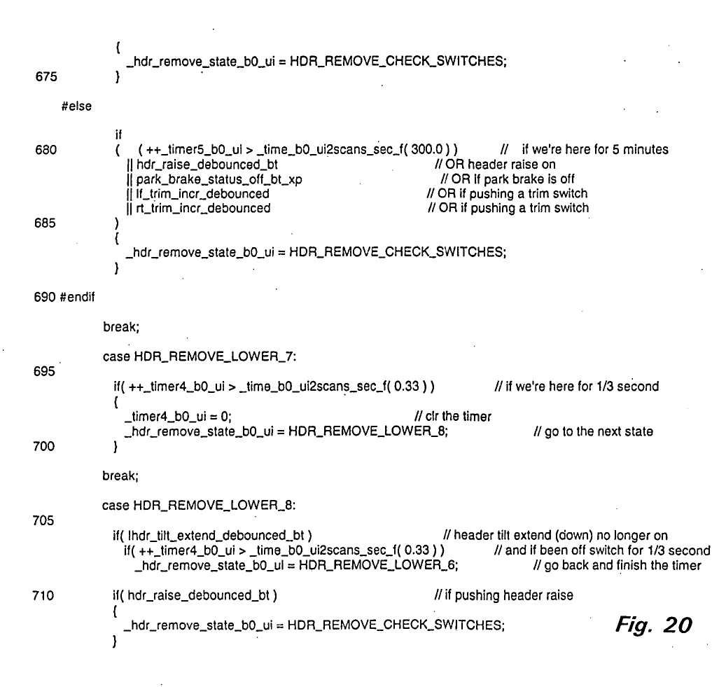

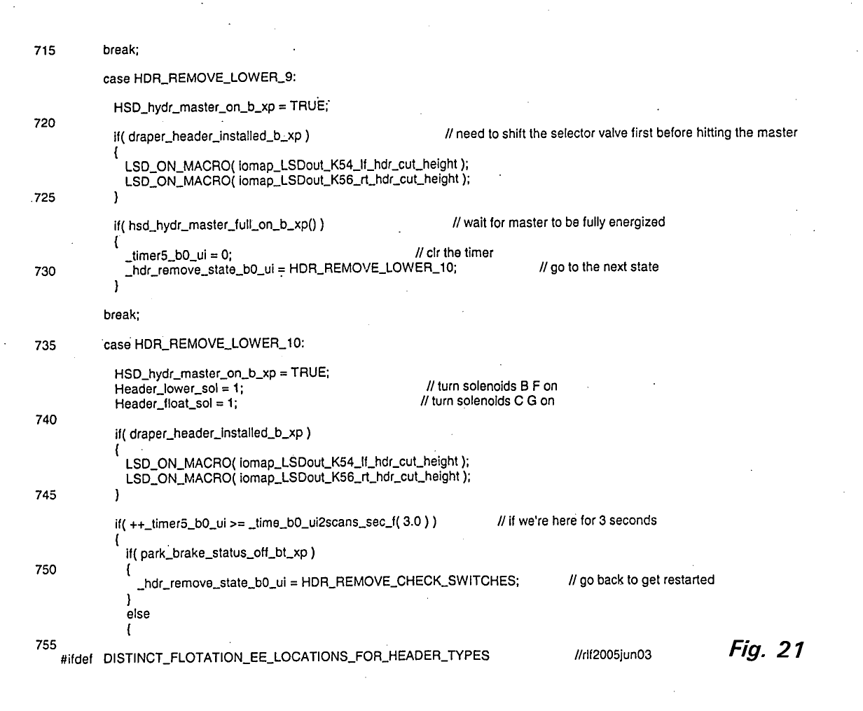

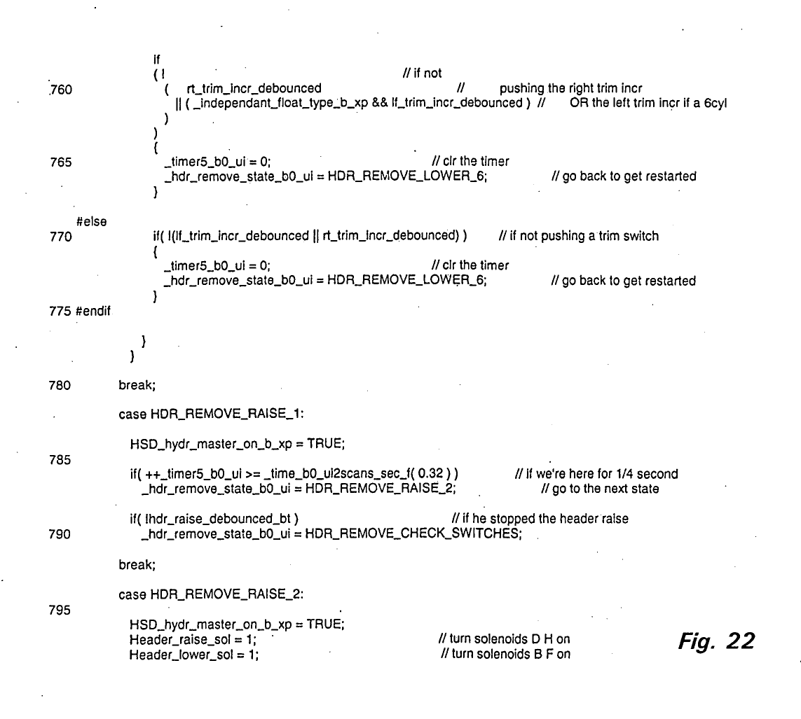

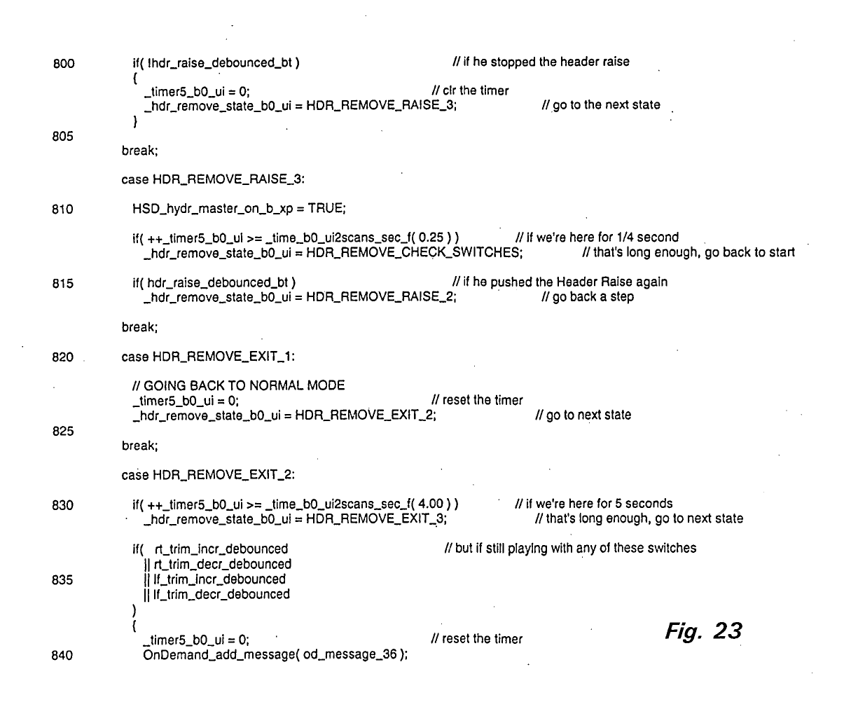

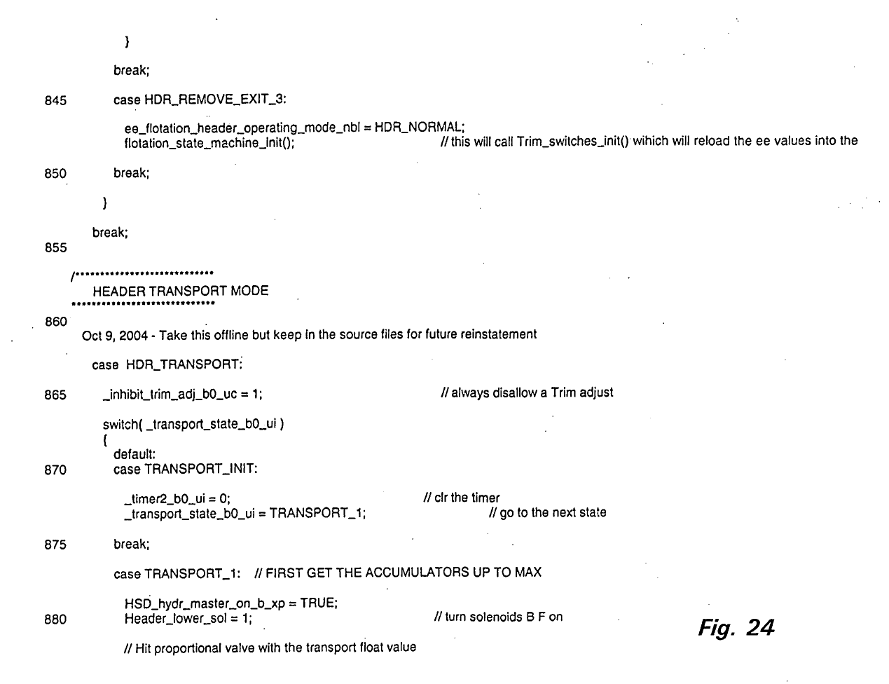

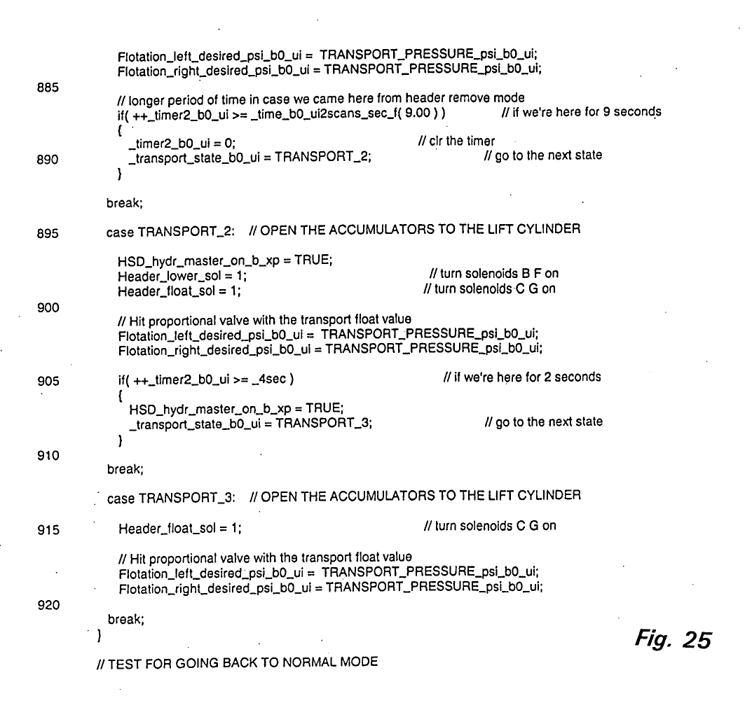

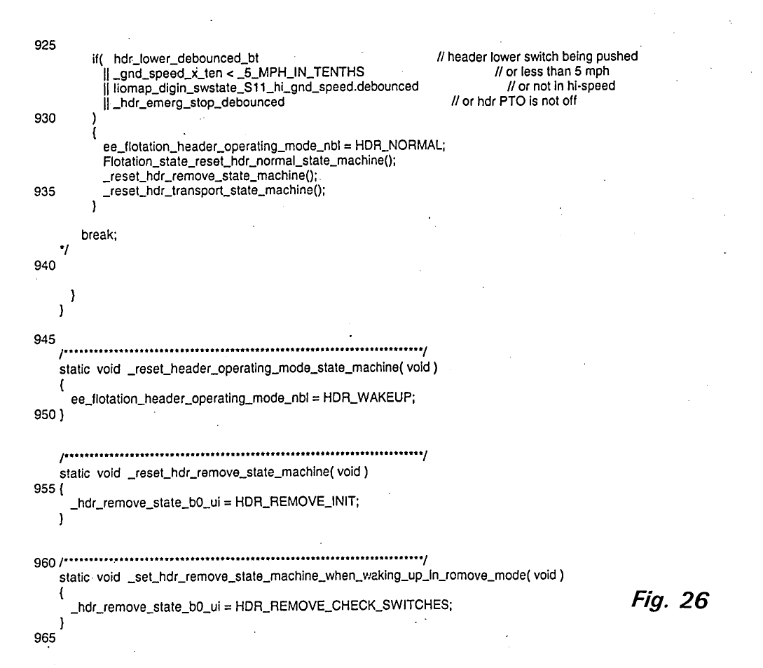

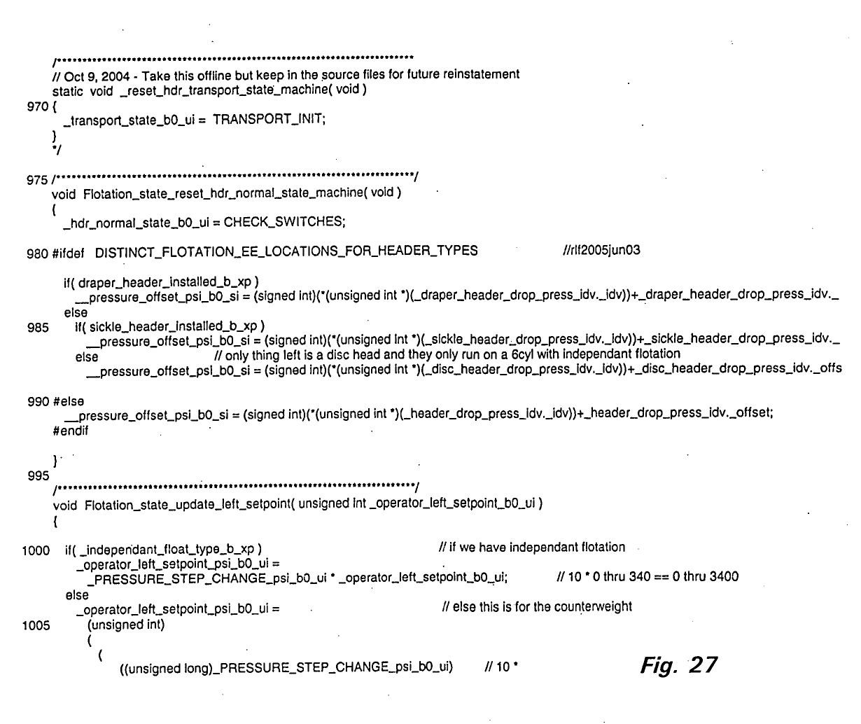

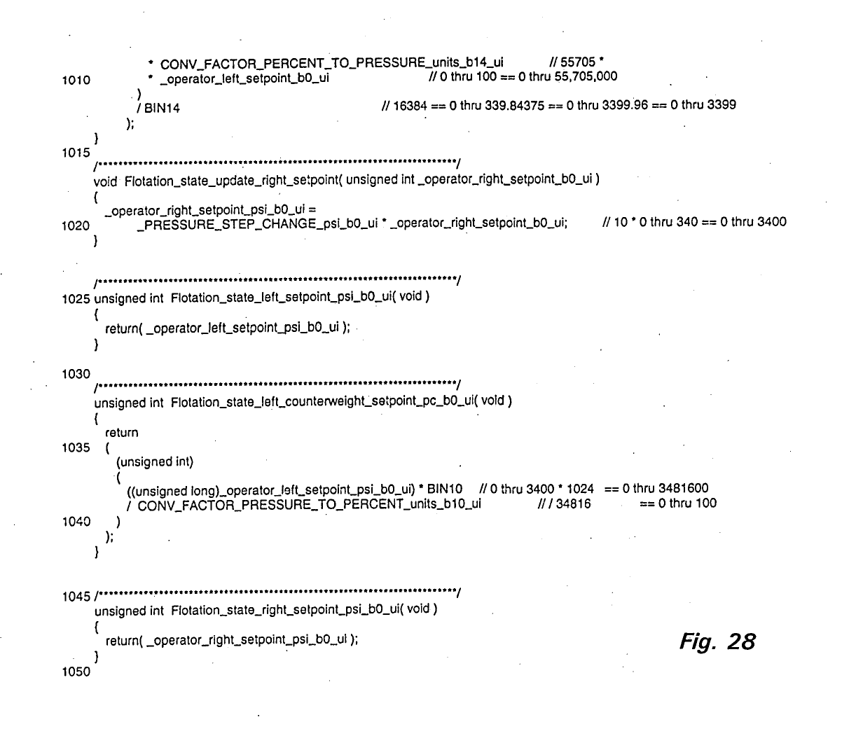

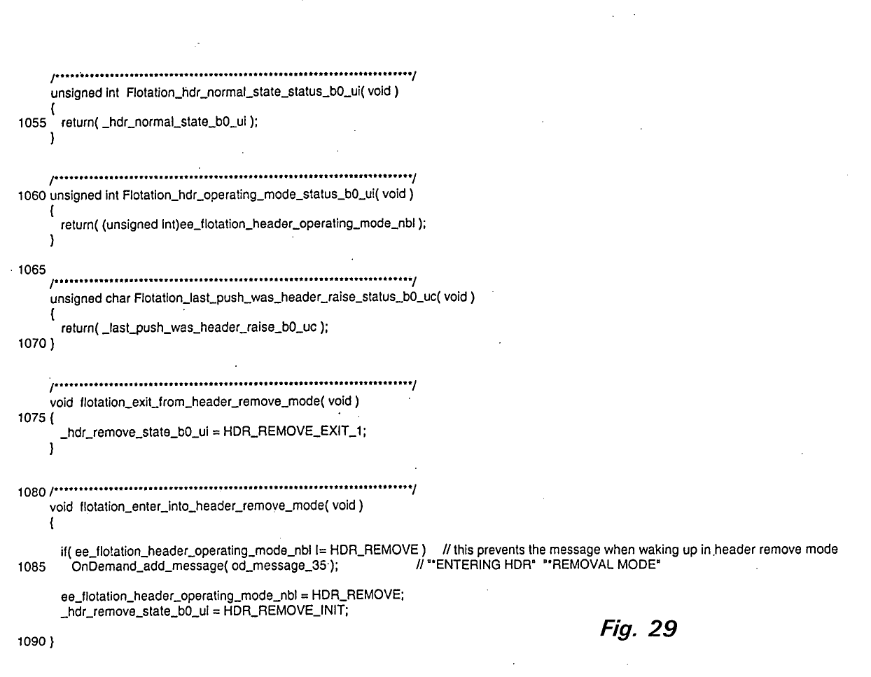

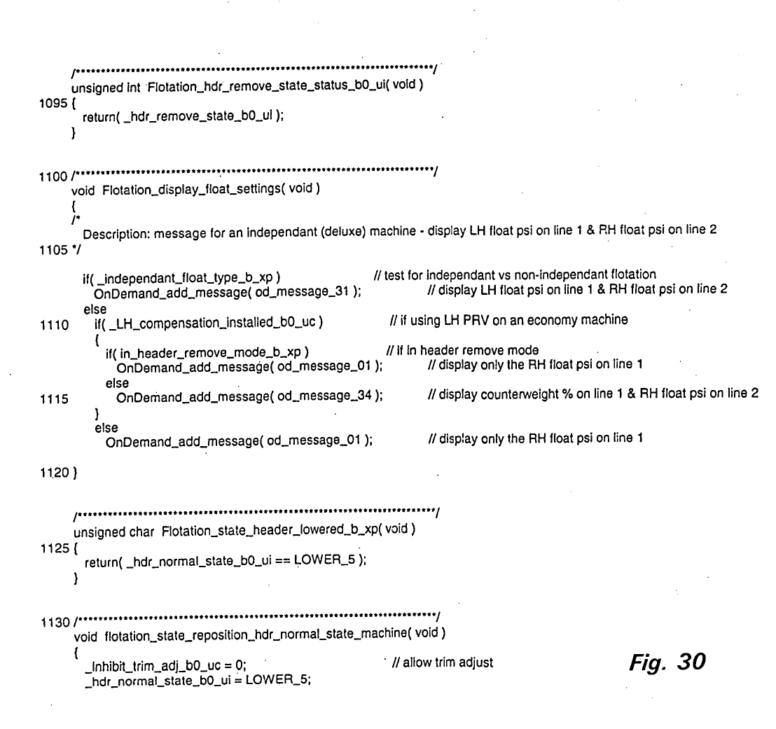

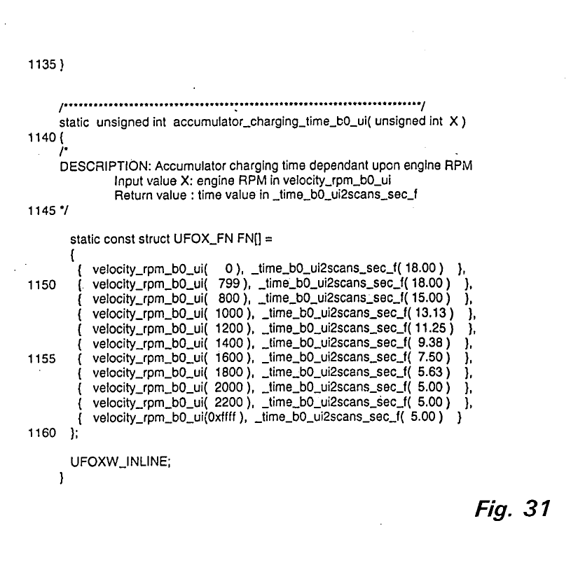

Directing attention to FIGS. 4 and 4a, a high-level flow diagram 70 illustrating steps of a preferred embodiment of a computer program incorporating a method of the invention for operating controller 50 and system 30 in a header remove mode, is shown. FIGS. 5 through 31 illustrate steps of the preferred program of the instant invention (see generally lines 540-1036). The notes on the program provide a very good explanation of the various line items and steps making up the program.

This program can be used with existing system as shown in U.S. Pat. No. 6,901,729 (non-independent embodiment), and also with an independent system such as disclosed in co-pending U.S. patent application Ser. No. 10/822,465, entitled Independent Hydraulic Header Lift and Flotation System, filed Apr. 12, 2004, both of which are incorporated herein by reference in their entirety. Four cylinder CNH windrowers do not have independent flotation systems, so they do not have the left side flotation components. In this invention, the available left side components are used to operate the counterbalance. In machine 10, down pressure is applied to the lighter side lift cylinder. The same basic control principle can be applied to PRV 58 to allow it to be used in a manner that supports the identified U.S. patent. In the program, PWM means pulse width modulation, and is expressed as a percentage.

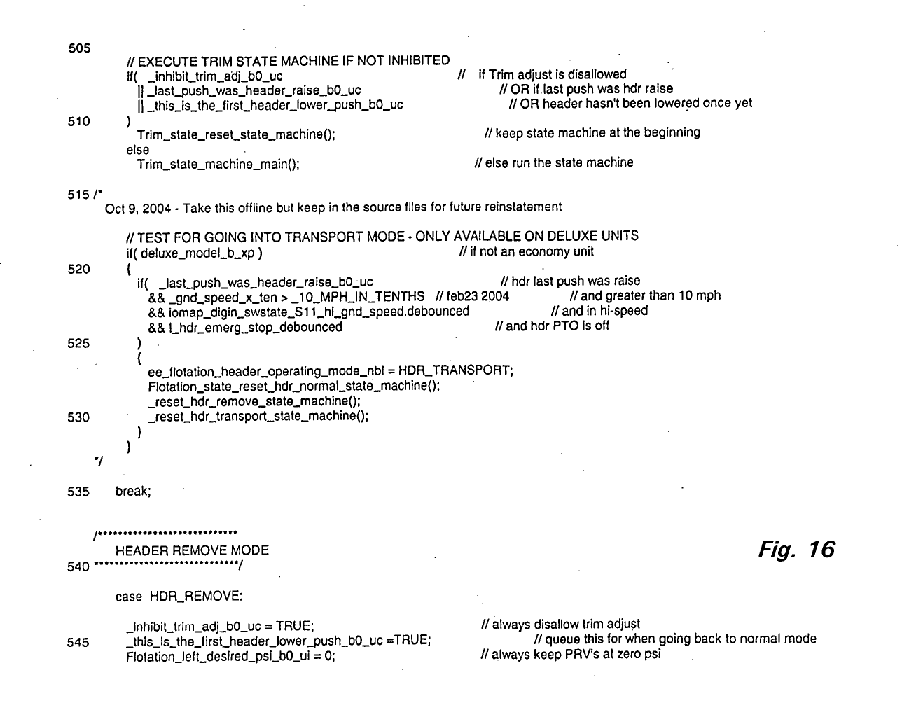

Directing attention to the program listing of FIGS. 16 through 24 (lines 540-855), and also continuing as denoted by balloon A from flow diagram 70 of FIGS. 4 and 4a, steps for operation in a header remove mode are shown. This mode is initiated by float switches 52 and 54 having been operated to drop the set point for the flotation force to zero, or near or about zero, as denoted by decision block 64. That is, a flotation force level which substantially ineffective for flotation purposes. This is because it is believed that the operator will typically not zero switches 52 and 54 unless it is desired to remove the header. When controller 50 recognizes or initiates the header remove mode, as denoted at block 68, it will naturally determine at decision block 72 that the trim switch set points are lower than 100 and will set the flotation force to zero (line 546) and clear or reset a 5 minute timer (line 567), as denoted at blocks 76 and 78. If a header raise command is present, as determined at decision block 80, controller 50 will set a flag (line 571), and will proceed to execute the command in due course (lines 782-820) by actuating valves 78 and 80 via solenoids D and H to raise arms 18, as denoted at block 82. This is done without first requiring charging the accumulators. Controller 50 will then remain in the header remove mode and return to decision block 80. If, at decision block 80, no header raise command is present, controller 50 will proceed, as denoted by following balloon D, to check for the presence of a header lower command, as denoted at decision block 84 in FIG. 4a. If no header lower command is present, following balloon E, controller 50 will remain in the header remove mode (PRVs at zero pressure such that flotation force equals zero), or go to some other suitable location such as to decision block 80. If, on the other hand, at decision block 84, a header lower command is detected, controller 50 will output a signal to the operator for a confirmation from the operator that a header lower command is desired (lines 580-585), as denoted at decision block 86. This required confirmation can be in the form of a predetermined operator input, such as another push of the header lower switch (line 582). If no confirmation is received, e.g., the switch is not pushed, controller 50 will disregard the command and follow balloon E and loop back to the top of the header remove routine, or to another suitable location, such as decision block 80. If, at decision block 86, the header lower command is confirmed, controller 50 will proceed to lower the arms, as denoted at block 88, and check for termination of a header lower command, as denoted at decision block 90. If the lower command is present the arms will continue to be lowered. If not, the controller will determine if the park brake is off, as denoted at decision block 92. If yes, it will follow balloon E to the top of the header remove mode. If no, it will continue to lower the arms as denoted at block 94, and proceed to check if the time is greater than 5 minutes, as denoted at block 96. If yes, the controller will follow balloon E to the top of the routine. If no, it will loop back to decision block 92.

The allotted five minute time is intended to allow the operator time to exit the cab and take necessary steps to disconnect or detach arms 18 from header 14, such as prying the arms loose from the cups on the header.

During the normal course of looping through to the top of the header remove routine at balloon E, controller 50 will determine if the trim switch set points are increased to 100 or more, as denoted at decision block 72, and if yes, controller 50 will exit the header remove mode, as denoted at block 74. If the set points are not increased to 100, controller 50 will remain looping through this header remove section until the exit condition is met.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions. Accordingly, the following claims are intended to protect the invention broadly as well as in the specific form shown.

What is claimed is:

1. A method of operation of a header lift and flotation system interconnecting a header and a frame of an agricultural harvesting machine, comprising steps of:
providing a programmable controller in operative control of the header lift and flotation system, the controller being automatically operable in a normal mode for controlling the system to raise the header when a header raise command is present, for controlling the system to lower the header when a header lower command is present, and to set a flotation force of the system equal to an inputted value therefor;
providing a device controllable by an operator for inputting a selectable value for the flotation force to the controller, including a value of zero or near zero and at least one value greater than near zero;
wherein responsive to an inputted value for the flotation force being zero or near zero, the controller is programmed to automatically operate in a header remove mode wherein the system will be controlled to hold the flotation force at the inputted value of zero or near zero, and thereafter, if the header lower command is present, then to operate the system to lower the header mode without first increasing the flotation force.

2. The method of claim 1, wherein when in the header remove mode, if the header raise command is present, the controller will continue to control the system to hold the flotation force at the inputted value of zero or near zero, and proceed to operate the system to raise the header.

3. The method of claim 1, wherein when in the header remove mode, when the header lower command is present, the controller will proceed to exit the header remove mode if an input to increase the flotation force to a predetermined value greater than the inputted value of zero or near zero is received.

4. The method of claim 3, wherein the predetermined value greater than the inputted value of zero or near zero comprises a value of at least 100 pounds.

5. The method of claim 1, wherein the device controllable by an operator for inputting a selectable value for the flotation force to the controller comprises a float switch.

6. A method of operation of a header lift and flotation system interconnecting a header and a frame of an agricultural harvesting machine in a header remove mode for facilitating removal of the header from the frame, comprising steps of:
providing a programmable controller in operative control of the header lift and flotation system, the controller being automatically operable in a normal mode for controlling the system to raise the header when a header raise command is present, for controlling the system to lower the header when a header lower command is present, and to set a flotation force of the system equal to an inputted value therefor;
providing a device controllable by an operator for inputting a selectable value for the flotation force to the controller, including a value of zero or near zero and at least one value greater than near zero;
wherein responsive to an inputted value for the flotation force being zero or near zero, the controller is programmed to automatically operate in a header remove mode wherein the system will be controlled to hold the flotation force at the inputted value of zero or near zero, including when either the header raise command or the header lower command is present.

7. The method of claim 6, wherein when in the header remove mode, if the header raise command is present, the controller will proceed to control the system to raise the header while holding the flotation force at the inputted value of zero or near zero.

8. The method of claim 6, wherein when in the header remove mode, when the header lower command is present, the controller will proceed to control the system to lower the header only if a confirmation command is received.

9. The method of claim 6, wherein the while in the header remove mode and the controller receives a header lower command and responsively controls the system for lowering the header, if a park brake is on, the controller will continue to control the system for lowering the header for a predetermined time period.

10. The method of claim 6, wherein the device controllable by an operator for inputting a selectable value for the flotation force to the controller comprises a float switch.

11. A header lift and flotation system interconnecting a header and a frame of an agricultural harvesting machine, comprising:
apparatus connecting the header to the frame, the apparatus including at least one arm in connection with a lift cylinder movable thereby upwardly for raising the header relative to the frame and downwardly for lowering the header relative to the frame, the arm being disconnectable from the lift cylinder to allow removing the header from the frame;
a programmable controller in operative control of the header lift and flotation system, the controller being automatically operable in a normal mode for controlling the lift cylinder to raise the header when a header raise command is present, to lower the header when a header lower command is present, and to set a flotation force of the system equal to an inputted value therefor;
a device controllable by an operator for inputting a selectable value for the flotation force to the controller, including a value of zero or near zero and at least one value greater than near zero; and
wherein the controller is programmed such that when the flotation force is set to a value of zero or near zero, the controller will automatically operate in a header remove mode to control the system to hold the flotation force at the set value of zero or near zero, including when either of the header raise command or the header lower command is present.

12. The system of claim 11, wherein the controller is programmed such that when in the header remove mode, if the header raise command is present, the controller will control the system to raise the header while holding the flotation force at the set value of zero or near zero.

13. The system of claim 11, wherein when the controller is in the header remove mode and the header lower command is present, the controller is programmed to proceed to control the system for lowering the header for a predetermined time period if a park brake is on.

14. The system of claim 11, wherein the predetermined value greater than the set value of zero or near zero comprises a previously set value greater than zero or near zero.

15. The system of claim 11, wherein the device controllable by an operator comprises a float switch.
